(19) United States
(12) Patent Application Publication
(10) Pub. No.: US 2025/0132312 A1
(43) Pub. Date: Apr. 24, 2025

(54) Lithium-Ion Rechargeable Battery

(71) Applicants: TOYOTA BATTERY Co., Ltd., Shizuoka (JP); TOYOTA JIDOSHA KABUSHIKI KAISHA, Aichi-Ken (JP); PRIME PLANET ENERGY & SOLUTIONS, INC., Tokyo (JP)

(72) Inventors: Katsuya Tanaka, Kobe shi (JP); Yoshinori Kudo, Toyohashi-shi (JP)

(21) Appl. No.: 18/920,574

(22) Filed: Oct. 18, 2024

(30) Foreign Application Priority Data
Oct. 24, 2023 (JP) 2023182584

(51) Int. Cl. H01M 4/36; H01M 4/02; H01M 4/38; H01M 4/505; H01M 4/525; H01M 10/0525; H01M 50/491

(52) U.S. Cl. CPC H01M 4/364; H01M 4/382; H01M 4/505; H01M 4/525; H01M 10/0525; H01M 50/491; H01M 2004/027; H01M 2004/028

(57) ABSTRACT

A lithium-ion rechargeable battery includes an electrode body in which a cathode sheet and an anode sheet are stacked with a separator arranged in between. An opposing surface of an anode mixture layer in the anode sheet is greater in size than an opposing surface of a cathode mixture layer in the cathode sheet. The anode mixture layer contains greater than or equal to 1000 ppm and less than or equal to 1500 ppm of lithium in advance. The anode mixture layer has a density of 1.1 g/cc or greater and 1.4 g/cc or less. The cathode mixture layer contains a lithium transition metal oxide as a cathode active material. A Li/M ratio of a number (Li) of atoms of lithium to a sum (M) of a number of atoms of a transition metal in the lithium transition metal oxide is 1.16 or greater and 1.20 or less.

### CROSS-REFERENCE TO RELATED APPLICATIONS

This application is based upon and claims the benefit of priority from prior Japanese Patent Application No. 2023-182584, filed on Oct. 24, 2023, the entire contents of which are incorporated herein by reference.

### BACKGROUND

### 1. Field

The following description relates to a lithium-ion rechargeable battery.

### 2. Description of Related Art

A typical electrode body of a lithium-ion rechargeable battery is formed by, for example, stacking a cathode sheet and an anode sheet with a separator disposed in between. These electrode sheets are each formed by applying an electrode mixture to a substrate, which serves as a current collector. Japanese Laid-Open Patent Publication Nos. 2018-056412 and 7-192766 describe such a lithium-ion rechargeable battery in which an anode mixture forming the anode sheet contains lithium in advance.

Accordingly, the output of the lithium-ion rechargeable battery may be improved by increasing the amount of lithium in a cathode mixture layer of the cathode sheet.

However, such a configuration may cause lithium ions to migrate to a non-opposing part of an anode mixture layer that does not face the cathode mixture layer, instead of moving back and forth between the opposing parts of the cathode mixture layer and the anode mixture layer. The escape of lithium ions from the cathode mixture layer to non-opposing part of the anode mixture layer may accelerate reduction of the battery capacity due to repeated charging and discharging. That is, the battery life may be shortened.

In this respect, in the above Patent Literature, the non-opposing part of the anode mixture layer contains a greater amount of lithium than the opposing part of the anode mixture layer in advance. This restricts an escape of lithium ions from the cathode mixture layer to the non-opposing part of the anode mixture layer, thereby extending the life of the lithium-ion rechargeable battery.

### SUMMARY

It is desired that the performance of a lithium-ion rechargeable battery be further improved for applications such as battery electric vehicles that are required to have high battery performance. Thus, there is a demand for a further improvement in the above described related art that meets the desired level of improvement in the lithium-ion rechargeable battery.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lithium-ion rechargeable battery includes an electrode body in which an electrode sheet of a cathode and an electrode sheet of an anode are stacked with a separator arranged in between. Each of the electrode sheets is formed by an electrode mixture applied to a substrate serving as a current collector. An opposing surface of an anode mixture layer in the electrode sheet of the anode is greater in size than an opposing surface of a cathode mixture layer in the electrode sheet of the cathode. The anode mixture layer contains greater than or equal to 1000 ppm and less than or equal to 1500 ppm of lithium in advance. The anode mixture layer has a density that is greater than or equal to 1.1 g/cc and less than or equal to 1.4 g/cc. The cathode mixture layer contains a lithium transition metal oxide as a cathode active material. A Li/M ratio of a number (Li) of atoms of lithium to a sum (M) of a number of atoms of a transition metal in the lithium transition metal oxide is greater than or equal to 1.16 and less than or equal to 1.20.

In the above lithium-ion rechargeable battery, the lithium contained in the anode mixture layer in advance may derive from carboxymethyl cellulose lithium included in an anode mixture, which forms the anode mixture layer.

In the above lithium-ion rechargeable battery, the anode mixture may contain greater than or equal to 0.4 wt % and less than or equal to 0.6 wt % of the carboxymethyl cellulose lithium.

In the above lithium-ion rechargeable battery, the lithium transition metal oxide contained in the cathode mixture layer may include LiNiₓCo_{y}Mn_{z}O₂ (x+y+z=1,0<x<1, 0<y<1, 0<z<1).

In the above lithium-ion rechargeable battery, an anode capacity/cathode capacity ratio of the electrode sheet of the cathode and the electrode sheet of the anode may be greater than or equal to 1.6 and less than or equal to 1.8.

In the above lithium-ion rechargeable battery, an end region of each of the

electrode sheets may define an uncoated portion where the electrode mixture is not applied to the substrate. The electrode sheet of the anode may include the end region in which the uncoated has a width of 300 μm or less.

In the above lithium-ion rechargeable battery, the separator may have a porosity that is greater than or equal to 50% and less than or equal to 60%.

The present description increases the battery output and extends the battery life.

Other features and aspects will be apparent from the following detailed description, the drawings, and the claims.

### BRIEF DESCRIPTION OF THE DRAWINGS

FIG. 1 is a perspective view of a rechargeable battery. FIG. 2 is a diagram of a partially unrolled electrode body.

FIG. 3 is a side view of the rechargeable battery.

FIG. 4 is a diagram schematically illustrating a cathode sheet and an anode sheet arranged at opposite sides of a separator.

FIG. 5 is a diagram schematically illustrating a cathode sheet and an anode sheet arranged at opposite sides of a separator in a rechargeable battery of a reference example.

FIG. 6 is a diagram schematically illustrating an electrode sheet having a double-side stacking structure.

FIG. 7 is a table showing test results of the rechargeable battery.

FIG. 8 is a graph showing the relationship between a Li/M ratio and a battery output.

FIG. 9 is a graph showing the relationship between a lithium amount in an anode mixture layer and a deterioration rate.

FIG. 10 is a graph showing the relationship between a density of the anode mixture layer and the deterioration rate.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An embodiment of a rechargeable battery will now be described with reference to the drawings.

### Lithium-Ion Rechargeable Battery

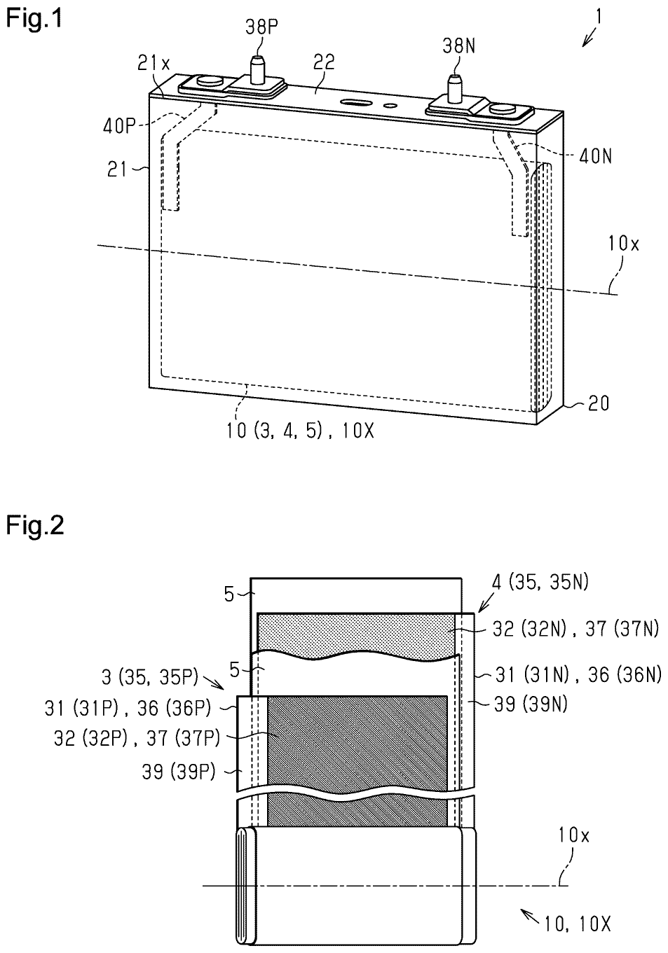

As shown in FIG. 1, a rechargeable battery 1 includes an electrode body 10 and a case 20 accommodating the electrode body 10. A cathode 3, an anode 4, and a separator 5 are integrated into the electrode body 10. The rechargeable battery 1 of the present embodiment may be a lithium-ion rechargeable battery in which the electrode body 10 is impregnated with a non-aqueous electrolyte solution (not shown) inside the case 20.

Specifically, in the rechargeable battery 1 of the present embodiment, the cathode 3, the anode 4, and the separator 5 are sheets that are stacked in a state in which the separator 5 is sandwiched between the cathode 3 and the anode 4. The stack of the cathode 3, the anode 4, and the separator 5 is rolled to form the electrode body 10 in which the cathode 3 and the anode 4 are alternately arranged in a radial direction of the roll with the separator 5 sandwiched between the cathode 3 and the anode 4.

Further, the case 20 of the present embodiment includes a flat, box-shaped case body 21 and a lid 22 that closes an open end 21x of the case body 21. The electrode body 10 of the present embodiment has a flattened shape in correspondence with the box shape of the case 20.

### Electrode Sheet and Electrode Body

More specifically, as shown in FIG. 2, in the rechargeable battery 1 of the present embodiment, the cathode 3 and the anode 4 each include an electrode sheet 35. The electrode sheet 35 includes a sheet of a current collector 31 and an electrode mixture layer 32 formed on the current collector 31.

Specifically, an electrode sheet 35P of the cathode 3 is formed by applying a mixture paste 37P, which is a cathode mixture, to a substrate 36P. The mixture paste 37P is an electrode mixture containing a lithium transition metal oxide that serves as a cathode active material. The substrate 36 is formed from aluminum or the like and serves as a cathode current collector 31P. The substrate 36P is, for example, a sheet or foil of a metal such as aluminum. Also, an electrode sheet 35N of the anode 4 is formed by applying a mixture paste 37N, which is an anode mixture, to a substrate 36N. The mixture paste 37N is a slurry of an electrode mixture containing a carbon-based material that serves as an anode active material. The substrate 36N is formed from copper or the like and serves as an anode current collector 31N. The substrate 36N is, for example, a sheet or foil of a metal such as copper. The mixture pastes 37P and 37N each contain a binder. In the rechargeable battery 1 of the present embodiment, the mixture pastes 37P and 37N are dried to form a cathode mixture layer 32P on the electrode sheet 35P of the cathode and an anode mixture layer 32N on the electrode sheet 35N of the anode.

In the rechargeable battery 1 of the present embodiment, the electrode sheet 35P of the cathode and the electrode sheet 35N of the anode are shaped into strips. The electrode body 10 of the present embodiment includes a roll 10X formed by rolling the electrode sheet 35P of the cathode and the electrode sheet 35N of the anode, which are arranged one upon the other with the separator 5 disposed in between, about a rolling axis 10x that extends in a widthwise direction of the strips (lateral direction in FIG. 2).

In FIG. 2, the separator 5 and the electrode sheets 35P and 35N are rolled with the electrode sheet 35P forming the cathode 3 arranged at the inner side. However, FIG. 2 merely shows an example of the structure of the electrode body 10. In another example, the separator 5 and the electrode sheets 35P and 35N may be rolled with the electrode sheet 35N forming the anode 4 arranged at the inner side. This determines whether the electrode sheet 35 arranged at the outermost part of the electrode body 10 is the electrode sheet 35P forming the cathode 3 or the electrode sheet 35N forming the anode 4.

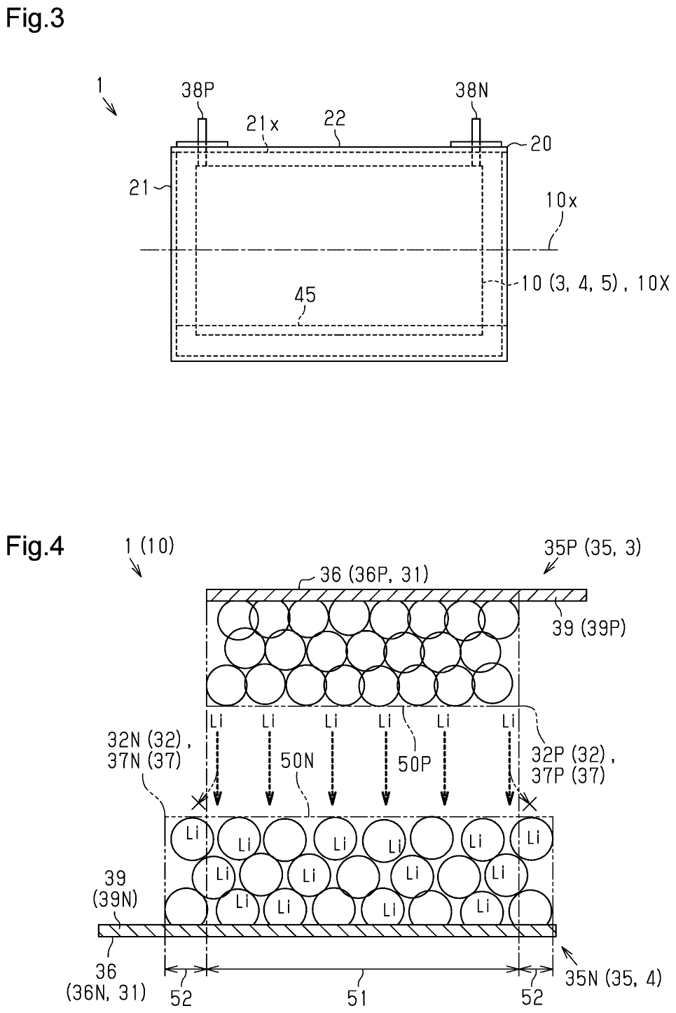

As shown in FIGS. 1 to 3, the lid 22 of the case 20 includes a cathode terminal 38P and an anode terminal 38N that project outward from the case 20. Further, each electrode sheet 35 includes an uncoated portion 39 where the electrode mixture layer 32 is not formed on the current collector 31. In the rechargeable battery 1 of the present embodiment, such uncoated portions 39 are used to electrically connect the electrode sheet 35P forming the cathode 3 to the cathode terminal 38P and the electrode sheet 35N forming the anode 4 to the anode terminal 38N.

Specifically, the electrode body 10 of the present embodiment is accommodated in the case 20 such that the rolling axis 10x extends in a longitudinal direction (lateral direction in FIG. 1) of the rectangular lid 22. In this state, an uncoated portion 39P of the electrode sheet 35P forming the cathode 3 is connected to the cathode terminal 38P by a connector 40P. In the same manner, an uncoated portion 39N of the electrode sheet 35N forming the anode 4 is connected to the anode terminal 38N by a connecting member 40N.

Further, an electrolyte solution 45 is injected into the case 20. The electrolyte solution 45 used in the rechargeable battery 1, which is a lithium-ion rechargeable battery, is obtained by dissolving a lithium salt serving as a supporting electrolyte in an organic solvent. In the rechargeable battery 1 of the present embodiment, the electrode body 10 is enclosed in the case 20 and is impregnated with the electrolyte solution 45.

### High Output and Longer Life

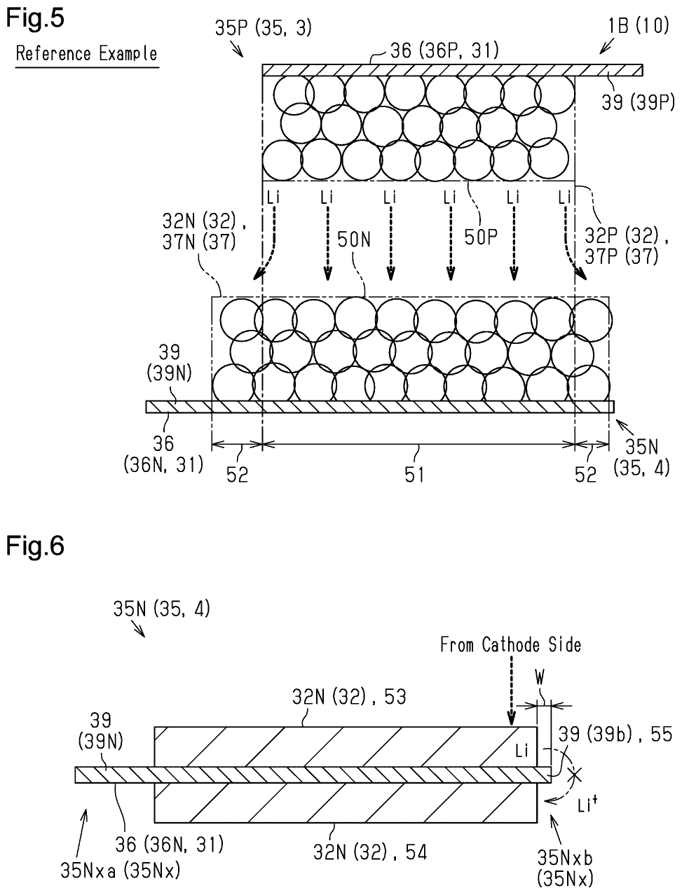

As shown in FIG. 4, in the rechargeable battery 1 of the present embodiment, when the electrode sheet 35P of the cathode and the electrode sheet 35N of the anode forming the electrode body 10 are compared to each other, the anode mixture layer 32N of the anode 4 is greater in size than the cathode mixture layer 32P of the cathode 3. Specifically, when the cathode mixture layer 32P and the anode mixture layer 32N facing each other with the separator 5 located in between are compared to each other, an opposing surface 50N of the anode mixture layer 32N is greater in size than an opposing surface 50P of the cathode mixture layer 32P. More specifically, the opposing surface 50N of the anode mixture layer 32N has a greater area than the opposing surface 50P of the cathode mixture layer 32P. To simplify illustration, the separator 5 is not shown in FIGS. 4 and 5. The anode mixture layer 32N of the present embodiment includes an opposing region 51 that faces the cathode mixture layer 32P, and a non-opposing region 52 that does not face the cathode mixture layer 32P.

The cathode mixture layer 32P forming the electrode sheet 35P of the cathode 3 as described above, that is, the mixture paste 37P serving as the cathode mixture applied to the substrate 36P, contains a lithium transition metal oxide as the cathode active material.

Specifically, in the rechargeable battery 1 of the present embodiment, the lithium transition metal oxide includes the following nickel-cobalt-manganese lithium oxide (NCM).

LiNiₓCo_{y}Mn_{z}O₂ (x+y+z=1,0<x<1,0<y<1,0<z<1)

Further, in the rechargeable battery 1 of the present embodiment, a Li/M ratio of the number (Li) of atoms of lithium to a sum (M) of the number of atoms of transition metal in the lithium transition metal oxide contained in the cathode mixture layer 32P is set to be greater than or equal to 1.16 and less than or equal to 1.20. The Li/M ratio may be expressed as “Li/Me ratio”. The Li/M ratio is equivalent to a ratio of mole numbers in the lithium transition metal oxide. In a typical lithium-ion rechargeable battery, the Li/M ratio is set to, for example, approximately 1.12 to 1.13. Thus, in the rechargeable battery 1 of the present embodiment, the Li/M ratio is set to be higher than usual. In this manner, the rechargeable battery 1 of the present embodiment contains a relatively large amount of lithium in the cathode mixture layer 32P.

In the rechargeable battery 1 of the present embodiment, the anode mixture layer 32N forming the electrode sheet 35N of the anode 4 also contains lithium. Specifically, in the rechargeable battery 1 of the present embodiment, the anode mixture layer 32N contains greater than or equal to 1000 ppm and less than or equal to 1500 ppm of lithium in advance before the initial charging of the rechargeable battery 1. The term “ppm” stands for “parts per million”. Further, the anode mixture layer 32N has a density that is set to be greater than or equal to 1.1 g/cc and less than or equal to 1.4 g/cc. This increases the output and extends the life of the rechargeable battery 1 of the present embodiment.

More specifically, in the rechargeable battery 1 of the present embodiment, the mixture paste 37N, which serves as the anode mixture applied to the substrate 36N to form the electrode sheet 35N of the anode 4, contains carboxymethyl cellulose, which acts as a thickener and a dispersant. The carboxymethyl cellulose is usually referred to as “CMC”. In the rechargeable battery 1 of the present embodiment, the CMC contained in the mixture paste 37N includes CMC-Li, which is lithium salt. In the rechargeable battery 1 of the present embodiment, CMC-Li is obtained by, for example, substituting cation (Na) of sodium carboxymethyl cellulose (CMC-Na) with Li. Specifically, the mixture paste 37N, which serves as the anode mixture of the rechargeable battery 1 of the present embodiment, contains greater than or equal to 0.4 wt % and less than or equal to 0.6 wt % of CMC-Li. This sets the amount of lithium contained in the anode mixture layer 32N to be greater than or equal to 1000 ppm and less than or equal to 1500 ppm in the rechargeable battery 1 of the present embodiment.

In the rechargeable battery 1 of the present embodiment, an anode capacity/cathode capacity ratio of the electrode sheet 35P of the cathode and the electrode sheet 35N of the anode forming the electrode body 10 is, for example, set to be greater than or equal to 1.6 and less than or equal to 1.8. In a typical lithium-ion rechargeable battery, the anode capacity/cathode capacity ratio is, for example, approximately 1.2 to 1.3. In the rechargeable battery 1 of the present embodiment, the separator 5 has a porosity that is, for example, set to be greater than or equal to 50% and less than or equal to 60%.

### Operation

A rechargeable battery 1B of a reference example shown in FIG. 5 contains NCM as the cathode active material in the cathode mixture layer 32P, in the same manner as the rechargeable battery 1 of the present embodiment. Further, the Li/M ratio of NCM is also set to be higher than usual. Thus, the rechargeable battery 1B of the reference example also contains a relatively large amount of lithium in the cathode mixture layer 32P.

On the other hand, in the rechargeable battery 1B of the present reference example, the anode mixture layer 32N does not contain lithium. Further, the density of the anode mixture layer 32N is greater than 1.4 g/cc.

When the Li/M ratio is increased, the cathode mixture layer 32P contains a larger amount of lithium. This increases the output of the rechargeable battery 1. However, such a “high-Li-containing cathode” may cause lithium ions that normally migrate from the cathode mixture layer 32P to the opposing region 51 of the anode mixture layer 32N to also move to the non-opposing region 52 during charging. As a result, such an escape of lithium ions from the cathode mixture layer 32P to the non-opposing region 52 of the anode mixture layer 32N may accelerate reduction of the battery capacity due to repeated charging and discharging.

In this respect, as shown in FIG. 4, the rechargeable battery 1 of the present embodiment contains lithium in advance in the anode mixture layer 32N having the non-opposing region 52. Thus, even when a “high-Li-containing cathode” is used, an escape of the lithium ions from the cathode mixture layer 32P to the non-opposing region 52 of the anode mixture layer 32N will be restricted. Further, in the rechargeable battery 1 of the present embodiment, the anode mixture layer 32N has a lower density than the rechargeable battery 1B of the above reference example. This facilitates permeation of the electrolyte solution 45 through the anode mixture layer 32N. Such a relatively high permeability of the electrolyte solution 45 through the anode mixture layer 32N allows the opposing region 51 of the anode mixture layer 32N facing the cathode mixture layer 32P to readily receive lithium ions migrated from the cathode mixture layer 32P. As a result, an escape of the lithium ions from the cathode mixture layer 32P to the non-opposing region 52 of the anode mixture layer 32N is further restricted. This increases the battery output and extends the life of the rechargeable battery 1 of the present embodiment.

If the Li/M ratio is overly high, lithium transition metal oxide (NCM) used as the cathode active material may not be able to maintain its structure. Further, an increase in the amount of lithium in the anode mixture layer 32N reduces the concentration gradient of lithium between the cathode 3 and the anode 4. When the density of the anode mixture layer 32N is relatively low, the permeability of the electrolyte solution 45 is increased, which in turn, facilitates the battery reaction of the rechargeable battery. This may also accelerate deterioration of the rechargeable battery.

In these respects, in the rechargeable battery 1 of the present embodiment, the Li/M ratio of the cathode 3 is set to be greater than or equal to 1.16 and less than or equal to 1.20, as described above. Further, the amount of lithium in the anode mixture layer 32N is set to be greater than or equal to 1000 ppm and less than or equal to 1500 ppm. The density of the anode mixture layer 32N is set to be greater than or equal to 1.1 g/cc and less than or equal to 1.4 g/cc.

The CMC-Li contained in the mixture paste 37N, which serves as the anode mixture, acts as a thickener. Thus, an increase in the content of CMC-Li is likely to increase the viscosity of the mixture paste 37N. This may hinder kneading of the mixture paste 37N and application of the mixture paste 37N to the substrate 36N.

In this respect, in the rechargeable battery 1 of the present embodiment, the amount of CMC-Li contained in the mixture paste 37N is set to be greater than or equal to 0.4 wt % and less than or equal to 0.6 wt %. Further, in the rechargeable battery 1 of the present embodiment, when the amount of CMC-Li contained in the mixture paste 37N is 0.6 wt %, which is the upper limit value of the preferred range, the amount of lithium contained in the anode mixture layer 32N becomes equal to 1500 ppm, which is the upper limit value of the preferred range. This allows the rechargeable battery 1 of the present embodiment to readily adjust the amount of lithium contained in the anode mixture layer 32N with high precision.

The anode capacity/cathode capacity ratio of the electrode sheet 35P of the cathode and the electrode sheet 35N of the anode forming the electrode body 10 has a tendency of reflecting the difference in size between the opposing surface 50N of the anode mixture layer 32N and the opposing surface 50P of the cathode mixture layer 32P, which face each other with respect to the separator 5. Typically, an increase in the anode capacity/cathode capacity ratio enlarges the non-opposing region 52 of the anode mixture layer 32N. In other words, in the electrode sheet 35N of the anode 4, the distance between the uncoated portion 39N and the opposing region 51 is increased by the non-opposing region 52 located between the uncoated portion 39N and the opposing region 51. That is, the uncoated portion 39N of the anode 4 becomes further spaced apart from a position where the opposing region 51 faces the cathode mixture layer 32P. This restricts migration of lithium ions from the cathode mixture layer 32P toward the uncoated portion 39N of the anode 4.

In the rechargeable battery 1 of the present embodiment, the lithium contained in the anode mixture layer 32N in advance restricts an escape of lithium from the cathode mixture layer 32P toward the non-opposing region 52 of the anode mixture layer 32N. Accordingly, even when the non-opposing region 52 of the anode mixture layer 32N is enlarged by an increase in the anode capacity/cathode capacity ratio, the battery capacity will not be easily reduced by repeated charging and discharging.

In this manner, the rechargeable battery 1 of the present embodiment restricts lithium deposition on the uncoated portion 39N of the anode 4. This avoids occurrence of short-circuit failures that would be caused by lithium deposition, thereby ensuring a high level of safety and reliability.

As shown in FIG. 6, the rechargeable battery 1 of the present embodiment includes the electrode sheet 35N of the anode 4 arranged at the outermost part of the electrode body 10, in which only one of two anode mixture layers 32N and 32N formed on two opposite surfaces of the substrate 36N faces the cathode mixture layer 32P. To simplify illustration, the electrode sheet 35P of the cathode 3 and the separator 5 are not shown in FIG. 6. In FIG. 6, one of the two anode mixture layers 32N and 32N that is arranged at the radially inner side (upper side in FIG. 6) of the electrode body 10, which is configured as the roll 10X, defines an opposing layer 53 that faces the cathode mixture layer 32P. The anode mixture layer 32N arranged at the radially outer side (lower side in FIG. 6) of the roll 10X defines a non-opposing layer 54 that does not face the cathode mixture layer 32P.

If the anode mixture layers 32N and 32N do not contain lithium, as in the rechargeable battery 1B of the above reference example, lithium ions may migrate from the opposing layer 53 over an end region 35Nx of the electrode sheet 35N toward the non-opposing layer 54. Specifically, as the opposing layer 53 receives lithium ions from the opposing cathode mixture layer 32P during charging, the amount of lithium increases in the opposing layer 53. In contrast, there is no cathode mixture layer 32P that would increase the amount of lithium in the non-opposing layer 54. Further, the electrolyte solution 45 is also present in the end region 35Nx of the electrode sheet 35N. Thus, migration of lithium ions from the opposing layer 53 over the end region 35Nx toward the non-opposing layer 54 may occur in accordance with the concentration gradient. This may decrease the effective amount of lithium, which in turn, accelerates reduction of the battery capacity due to repeated charging and discharging.

However, in the rechargeable battery 1 of the present embodiment, the opposing layer 53 and the non-opposing layer 54 both contain lithium in advance. Thus, even when the amount of lithium in the opposing layer 53 increases during charging, the concentration gradient between the opposing layer 53 and the non-opposing layer 54a formed in the end region 35Nx of the electrode sheet 35N will be relatively small. In this manner, the rechargeable battery 1 of the present embodiment minimizes migration of lithium ions from the opposing layer 53 over the end region 35Nx toward the non-opposing layer 54.

In the rechargeable battery 1 of the present embodiment, the electrode sheet 35N of the anode 4 includes the uncoated portion 39N (refer to FIG. 2), which is used for terminal connection, in an end region 35Nxa located at one side (left side in FIG. 6) in the widthwise direction of the strips rolled into the electrode body 10. Further, the electrode sheet 35N includes a cut end 55 in an end region 35Nxb located at the other side (right side in FIG. 6) in the widthwise direction of the strips rolled into the electrode body 10. The cut end 55 is formed when shaping the electrode sheet 35N into a strip. In the electrode sheet 35N of the present embodiment, the cut end 55 also defines an uncoated portion 39b where the anode mixture layer 32N is not formed on the substrate 36N. In the electrode sheet 35N of the present embodiment, the uncoated portion 39b defined by the cut end 55 has a width W of 300 μm or less.

As the uncoated portion 39 formed in the end region 35Nx of the electrode sheet 35N is widened, lithium ions become less likely to migrate from the opposing layer 53 over the end region 35Nx toward the non-opposing layer 54. However, the rechargeable battery 1 of the present embodiment minimizes migration of lithium ions from the opposing layer 53 over the end region 35Nx toward the non-opposing layer 54 regardless of the uncoated portion 39. Thus, in the rechargeable battery 1 of the present embodiment, the uncoated portion 39b in the end region 35Nxb may be narrowed, as described above. This ensures a high degree of freedom for designing the electrode sheet 35N of the anode 4.

In order to restrict migration of lithium ions from the opposing layer 53 over the end region 35Nx of the electrode sheet 35N toward the non-opposing layer 54, the porosity of the separator 5 may be decreased. Such a configuration lowers a retainability of the separator 5 to hold the electrolyte solution 45. This decreases the permeability of lithium ions, thereby restricting migration of lithium ions over the end region 35Nx.

Nonetheless, when the porosity of the separator 5 is relatively low, the decrease in the retainability of the separator 5 may easily degrade the cycling performance during repeated charging and discharging. If the porosity of the separator 5 is increased so as to ensure the retainability of the separator 5, the permeability of lithium ions will be increased such that lithium ions are more likely to migrate over the end region 35Nx of the electrode sheet 35N, as described above.

In these respects, in the rechargeable battery 1 of the present embodiment, the opposing layer 53 and the non-opposing layer 54 both contain lithium in advance so as to minimize migration of lithium ions from the opposing layer 53 over the end region 35Nx toward the non-opposing layer 54. This allows for an increase in the porosity of the separator 5 and improves the cycling performance of the rechargeable battery 1.

In the rechargeable battery 1 of the present embodiment, a lower limit of the porosity of the separator 5 is set in order to ensure the cycling performance. Further, an upper limit of the porosity is set based on the required mechanical strength of the separator 5. Accordingly, in the rechargeable battery 1 of the present embodiment, the porosity of the separator 5 is set to be greater than or equal to 50% and less than or equal to 60%, as described above.

The present embodiment has the following advantages.

(1) The rechargeable battery 1, which is a lithium-ion rechargeable battery, includes the electrode body 10 in which the electrode sheet 35 of the cathode and the electrode sheet 35 of the anode are stacked with the separator 5 arranged in between. Each of the electrode sheets 35 is formed by applying the mixture paste 37, which serves as the electrode mixture, to the substrate 36, which serves as the current collector 31. The opposing surface 50N of the anode mixture layer 32N in the electrode sheet 35N of the anode 4 is greater in size than the opposing surface 50P of the cathode mixture layer 32P in the electrode sheet 35P of the cathode 3. The anode mixture layer 32N contains greater than or equal to 1000 ppm and less than or equal to 1500 ppm of lithium, and the density of the anode mixture layer 32N is set to be greater than or equal to 1.1 g/cc and less than or equal to 1.4 g/cc. The cathode mixture layer 32P includes a lithium transition metal oxide as the cathode active material. The Li/M ratio of the number (Li) of the atoms of lithium to the sum (M) of the number of atoms of transition metal oxide is set to be greater than or equal to 1.16 and less than or equal to 1.20.

The Li/M ratio is set to be relatively high such that the cathode mixture layer 32P contains a relatively large amount of lithium. This increases the battery output. Further, lithium is contained in advance in the anode mixture layer 32N having the non-opposing region 52, which does not face the cathode mixture layer 32P. This minimizes an escape of lithium from the cathode mixture layer 32P to the non-opposing region 52 of the anode mixture layer 32N. In addition, the density of the anode mixture layer 32N is relatively low such that the electrolyte solution 45 readily permeates through the anode mixture layer 32N. Accordingly, the opposing region 51 of the anode mixture layer 32N, which faces the cathode mixture layer 32P, readily receives lithium ions migrated from the cathode mixture layer 32P. This further restricts an escape of lithium from the cathode mixture layer 32P to the non-opposing region 52 of the anode mixture layer 32N. Therefore, the above configuration effectively increases the battery output and extends the battery life.

Furthermore, the above configuration is advantageous in that there is no need to set different lithium contents for the opposing region 51 and the non-opposing region 52. This facilitates the improvement of the battery output and the battery life.

(2) The lithium contained in the anode mixture layer 32N in advance derives from carboxymethyl cellulose lithium included in the mixture paste 37N, which is applied to the substrate 36 and forms the anode mixture layer 32N.

The mixture paste 37N serving as the anode mixture may include, for example, carboxymethyl cellulose (CMC) as a thickener and a dispersant. In the above configuration, CMC-Li, which is lithium salt, is used as CMC such that the anode mixture layer 32N readily contains lithium in advance.

(3) The mixture paste 37N serving as the anode mixture contains greater than or equal to 0.4 wt % and less than or equal to 0.6 wt % of carboxymethyl cellulose lithium.

The above configuration readily adjusts the amount of lithium contained in the anode mixture layer 32N in advance within the preferred range described in advantage (1). Further, the above configuration facilitates kneading and application of the mixture paste 37N taking into consideration the viscosity increasing effect of CMC-Li. This readily increases the battery output and extends the battery life.

(4) The cathode mixture layer 32P contains LiNiₓCo_{y}Mn_{z}O₂ (x+y +z=1, 0<x<1, 0<y<1, 0<z<1) as lithium transition metal oxide.

With the above configuration, the Li/M ratio is set to be relatively high such that the cathode mixture layer 32P contains a relatively large amount of lithium. This increases the battery output.

(5) The anode capacity/cathode capacity ratio of the electrode sheet 35P of the cathode and the electrode sheet 35N of the anode is greater than or equal to 1.6 and less than or equal to 1.8.

The electrode sheet 35N includes a portion of the substrate 36 where the anode mixture layer 32N is not formed, that is, the uncoated portion 39N in which the mixture paste 37N is not applied, in the end region 35Nx. Further, the relatively high anode capacity/cathode capacity ratio of the electrode sheet 35P of the cathode and the electrode sheet 35N of the anode forming the electrode body 10 enlarges the non-opposing region 52 of the anode mixture layer 32N. In other words, the uncoated portion 39N is further spaced apart from a position where the opposing region 51 faces the cathode mixture layer 32P by the non-opposing region 52P located between the opposing region 51 and the uncoated portion 39N. Furthermore, even when the non-opposing region 52 is relatively large, the configuration described in advantage (1), in which the non-opposing region 52 contains lithium in advance, restricts migration of lithium in the cathode mixture layer 32P to the non-opposing region 52. Therefore, the above configuration restricts migration of lithium ions from the cathode mixture layer 32P toward the uncoated portion 39N of the anode 4 while increasing the battery output and extending the battery life. This avoids occurrence of short-circuit failures that would be caused by lithium deposition on the uncoated portion 39N of the anode 4, thereby ensuring a high level of safety and reliability.

(6) The electrode sheet 35N of the anode 4 includes the end region 35Nx in which the width W of the uncoated portion 39N is 300 μm or less.

In the electrode body 10, one of two anode mixture layers 32N and 32N formed on two opposite surfaces of the substrate 36N may define the opposing layer 53, which faces the cathode mixture layer 32P, and the other one of the two anode mixture layers 32N and 32N may define the non-opposing layer 54, which does not face the cathode mixture layer 32P. Moreover, in this case, when the amount of lithium in the opposing layer 53 increases during charging, lithium ions may migrate from the opposing layer 53 over the end region 35Nx toward the non-opposing layer 54 in accordance with the concentration gradient formed in the end region 35Nx. This may decrease the effective amount of lithium, which in turn, accelerates deterioration of the battery capacity due to repeated charging and discharging

However, the configuration described in advantage (1), in which the non-opposing layer 54 also contains lithium in advance, minimizes migration of lithium ions from the opposing layer 53 over the end region 35Nx toward the non-opposing layer 54. Thus, uncoated portion 39N in the end region 35N may be narrowed. This ensures a high degree of design freedom while resisting reduction of the battery capacity due to repeated charging and discharging.

(7) The separator 5 has a porosity that is greater than or equal to 50% and less than or equal to 60%.

The above configuration ensures the retainability of the separator 5 to hold the electrolyte solution 45. This improves the cycling performance by reducing changes in the characteristics of the rechargeable battery 1 over repeated charging and discharging. The above configuration ensures a sufficient mechanical strength required by the separator 5.

When the retainability of the separator 5 to hold the electrolyte solution 45 is increased, lithium ions become more permeable through the separator 5. Accordingly, lithium ions become more likely to migrate from the opposing layer 53 over the end region 35x of the electrode sheet 35N toward the non-opposing layer 54. However, the configuration described in advantage (1), in which the non-opposing layer 54 also contains lithium in advance, minimizes migration of lithium ions from the opposing layer 53 over such an end region 35Nx toward the non-opposing layer 54. This resists reduction of the battery capacity due to repeated charging and discharging.

The above embodiment may be modified as follows. The above embodiment and the following modifications can be combined as long as the combined modifications remain technically consistent with each other.

In the above embodiment, the lithium contained in the anode mixture layer 32N in advance derives from carboxymethyl cellulose lithium included in the mixture paste 37N, which is applied to the substrate 36 and forms the anode mixture layer 32N. However, there is no limit to such a configuration, and the anode mixture layer 32N may contain lithium by any method.

The lithium transition metal oxide, which serves as the cathode active material contained in the cathode mixture layer 32P, does not have to be NCM and may be changed.

The amount of lithium contained in the anode mixture layer 32N in advance may be changed. The density of the anode mixture layer 32N may be changed. The Li/M ratio of lithium transition metal oxide contained in the cathode mixture layer 32P may be changed. However, it is preferred that these values be set within the preferred ranges described in the above embodiment.

The amount of carboxymethyl cellulose lithium contained in the mixture paste 37N may be changed. The anode capacity/cathode capacity ratio of the electrode sheet 35P of the cathode and the electrode sheet 35N of the anode may be changed. The porosity of the separator 5 may be changed. However, it is preferred that these values be set within the preferred range described in the above embodiment.

In the above embodiment, the electrode sheet 35N includes the cut end 55, which is formed when shaping the electrode sheet 35N into a strip, in the end region 35xb. The cut end 55 defines the uncoated portion 39b. The width W of the uncoated portion 39b is set to 300 μm or less. However, there is no limit to such a configuration, and the width W of the uncoated portion 39b may be changed. For example, the width W of the uncoated portion 39b may be 0 μm. Further, the end region 35Nxb may include the uncoated portion 39b having the width W of 300 μm or less at a portion that does not correspond to the cut end 55.

Each electrode sheet 35 may have a double-side stacking structure in which the electrode mixture layer 32 is formed on two opposite surfaces of the substrate 36. Alternatively, each electrode sheet 35 may have a single-side stacking structure in which the electrode mixture layer 32 is formed on only one of the surfaces of the substrate 36.

In the above embodiment, the electrode body 10 is configured as the roll 10X. However, the electrode sheet 35P of the cathode and the electrode sheet 35N of the anode do not have to be rolled with the separator 5 arranged in between.

The cathode terminal 38P and the anode terminal 38N do not have to be shaped as shown in FIG. 1. The case 20 that defines the contour of the rechargeable battery 1 does not have to be box-shaped, and may have any form, such as a cylindrical shape.

### EXAMPLES

Examples will now be described to illustrate the configuration and advantages of the present disclosure in further detail. However, the present disclosure is not limited to these examples.

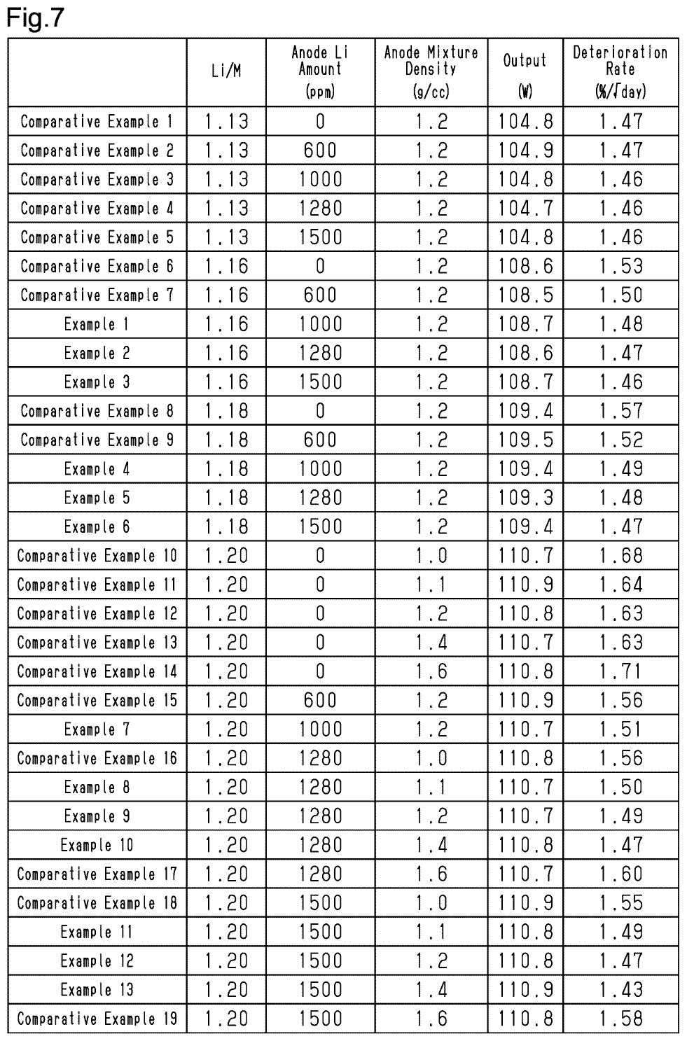

FIG. 7 is a table showing test results obtained by varying the Li/M ratio of lithium transition metal oxide contained in the cathode mixture layer 32P, the amount of lithium in the anode mixture layer 32N, and the density of the anode mixture layer 32N in the rechargeable battery 1. In these tests, the battery output and the battery life were evaluated as the performance of the rechargeable battery 1. A deterioration rate of the battery capacity was measured as an index for the battery life. The deterioration rate was obtained by measuring changes in the battery capacity between before and after storing the subject rechargeable battery 1 under a certain temperature environment for a predetermined period.

In FIG. 7, the unit of the battery output is “W”. The unit of the deterioration rate is “%/Vday”. Specifically, the deterioration rate of the battery capacity was evaluated in “a battery capacity decrease rate per square root day”. A smaller value in “%/Vday” indicates a lower deterioration rate. In other words, a smaller value “%/Vday” indicates that the subject rechargeable battery 1 has a relatively long life.

The amount of lithium (ppm) in the anode mixture layer 32N was measured as follows.

First, a test piece having a specified area was punched out from the electrode sheet 35N. Next, the test piece underwent ultrasonic dispersion in pure water to remove the anode mixture layer 32N from the substrate 36N. Then, nitric acid and hydrogen peroxide were used to dissolve the dispersed contents of the anode mixture layer 32N. After removing the residue using a membrane filter, ICP measurement was performed on the content of the anode mixture layer 32N to determine the amount of lithium (ppm). The “ICP measurement” stands for “inductively coupled plasma atomic emission spectroscopy”. The measurement device used was ICPE-9000 (manufactured by Shimadzu Corporation).

The density (g/cc) of the anode mixture layer 32N was measured as follows.

First, a test piece having a specified area was punched out from the electrode sheet 35N to measure the weight of the test piece (combined weight of anode mixture layer 32N and substrate 36N). Next, the anode mixture layer 32N was removed to measure the weight of the substrate 36N. The weight of the substrate 36N was subtracted from the measured weight of the test piece to obtain the weight of the anode mixture layer 32N. Then, the weight of the anode mixture layer 32N was divided by the punched area of the test piece to calculate “unit weight”. The unit of “unit weight” was “mg/square centimeter”.

Further, the thickness of the electrode sheet 35 and the thickness of the substrate 36N were measured using a point probe coating thickness gauge. The thickness of the substrate 36N is subtracted from the thickness of the electrode sheet 35 to obtain the thickness of the anode mixture layer 32N. Then, “unit weight” was divided by the thickness of the anode mixture layer 32N to calculate the density (g/cc) of the anode mixture layer 32N.

The porosity (%) of the separator 5 was measured as follows.

First, a short strip was punched out from the separator 5 to measure the weight of the strip. This weight measurement was performed independently three times (N=3). Further, a theoretical weight was calculated from the specific gravity of the resin member used in the separator 5. Then, the porosity (%) of the separator 5 was obtained by calculating “weight measurement (average of N=3)/theoretical weight value×100”.

### Relationship Between Amount of Lithium in Anode Mixture Layer and Battery Output

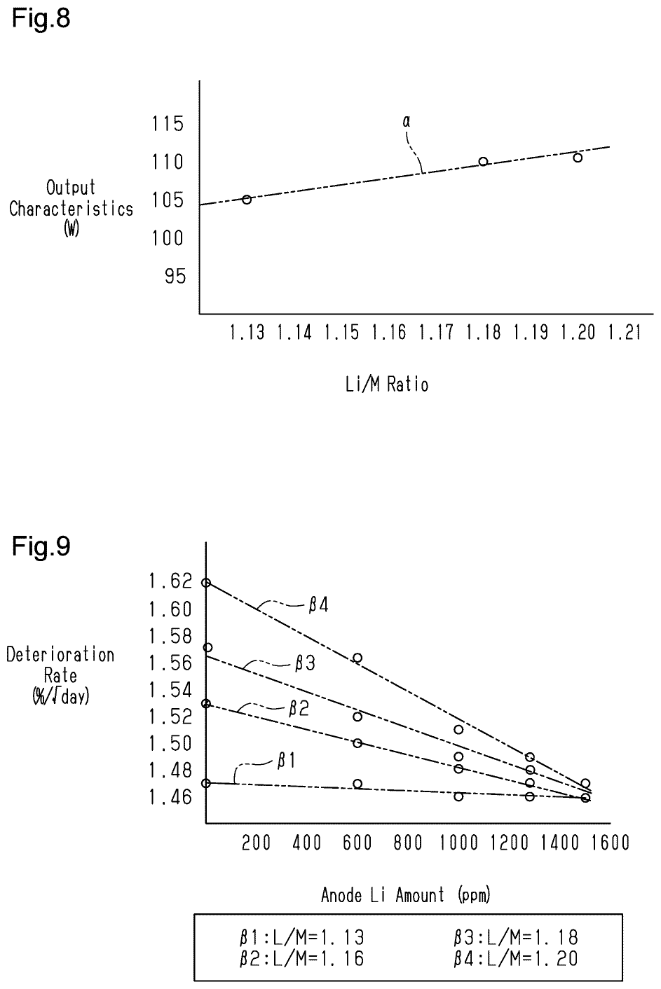

As shown in FIGS. 7 and 8, the test results of Example 1 to Example 13 and Comparative Example 1 to Comparative Example 19 indicate that the battery output had a tendency of increasing as the Li/M ratio of lithium transition metal oxide contained in the cathode mixture layer 32P increased. It can be understood that such a tendency was obtained because an increase in the Li/M ratio increased the amount of lithium in the cathode mixture layer 32P.

When the Li/M ratio was the same, even if the amount of lithium in the anode mixture layer 32N and the density of the anode mixture layer 32N varied, the battery output had no significant difference. Accordingly, FIG. 8 only shows an approximation line a that represents the tendency of the battery output to increase substantially linearly as the Li/M ratio increased in cases in which the amount of lithium in the anode mixture layer 32N was 0 ppm and the density of the anode mixture layer 32N was 1.2 g/cc.

### Relationship Between Anode Li Amount and Deterioration Rate

As shown in FIGS. 7 and 9, the test results indicate that the deterioration rate of the battery capacity had a tendency of decreasing as the amount of lithium in the anode mixture layer 32N increased. In FIG. 9, an approximation line β1 corresponds to cases in which the Li/M ratio was 1.13, and an approximation line β2 corresponds to cases in which the Li/M ratio was 1.16. In the same drawing, an approximation line β3 corresponds to cases in which the Li/M ratio was 1.18, and an approximation line β4 corresponds to cases in which the Li/M ratio was 1.20. In each of the above cases, the density of the anode mixture layer 32N was 1.2 g/cc. The approximation lines β1 to β4 each show that the deterioration rate had a tendency of improving substantially linearly as the amount of lithium in the anode mixture layer 32N increased.

Specifically, when the Li/M ratio was 1.16 or greater, the battery life was outstandingly extended by the lithium contained in the anode mixture layer 32N in advance. Also, when the amount of lithium contained in the anode mixture layer 32N in advance was greater than or equal to 1000 ppm, the battery life was further outstandingly extended from that when the amount of lithium was 0 ppm. These test results confirmed that 1.16 of the Li/M ratio and 1000 ppm of the amount of lithium contained in advance in the anode mixture layer 32N are both appropriate values for the lower limits of the preferred ranges described in the above embodiment.

The approximation lines β3 and β4, corresponding to cases in which the Li/M ratio were relatively high, show that even when the amount of lithium contained in the anode mixture layer 32N was 600 ppm, the lithium contained in the anode mixture layer 32N sufficiently extended the battery life. Therefore, it can be understood that the lower limit for the preferred range of the amount of lithium contained in the anode mixture layer 32N may be extended to, for example, 600 ppm.

Relationship Between Density of Anode Mixture Layer and Deterioration Rate

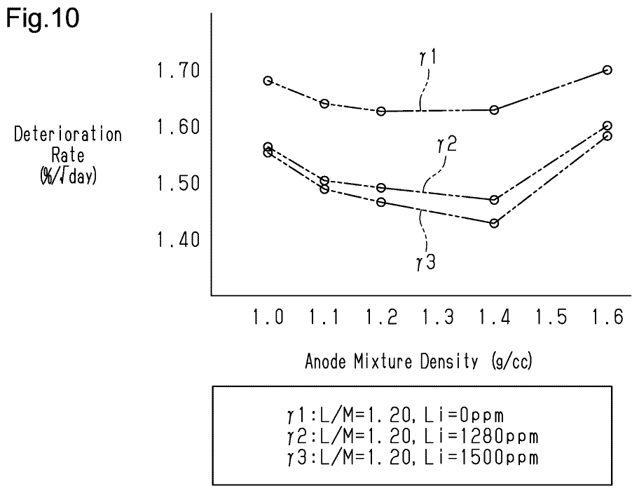

As shown in FIGS. 7 and 10, the test results indicate that when the density of the anode mixture layer 32N was less than or equal to 1.4 g/cc, the deterioration rate of the battery capacity became lower than when the density of the anode mixture layer 32N was 1.6 g/cc. In FIG. 10, an approximation line γ1 corresponds to cases in which the amount of lithium contained in the anode mixture layer 32N in advance was 0 ppm, an approximation line γ2 corresponds to cases in which the lithium amount was 1280 ppm, and an approximation line γ3 corresponds to cases in which the lithium amount was 1500 ppm. In each of the above cases, the Li/M ratio of the cathode mixture layer 32P was 1.20.

Further, when the cases in which the density of the anode mixture layer 32N was less than or equal to 1.4 g/cc are compared, the approximation lines γ1 to γ3 show that the deterioration rate became higher as the density decreased. It can be understood that an increase in the permeability of the electrolyte solution 45 facilitated the battery reaction and, in turn, accelerated deterioration of the battery.

Furthermore, the approximation lines γ1 to γ3 show that the battery life was further outstandingly extended when the density of the anode mixture layer 32N was greater than or equal to 1.1 g/cc. These test results confirmed that 1.1 g/cc is an appropriate value for the lower limit of the preferred range for the density of the anode mixture layer 32N described in the above embodiment, and 1.4 g/cc is an appropriate value for the upper limit of the preferred range.

The approximation lines γ2 and γ3, which correspond to cases in which lithium was present in the anode mixture layer 32N, show that the battery life was sufficiently extended even when the density of the anode mixture layer 32N was 1.0 g/cc. Therefore, it can be understood that the lower limit of the preferred range of the density of the anode mixture layer 32N may be extended to 1.0 g/cc.

### Verification

The preferred ranges of the Li/M ratio, the amount of lithium in the anode mixture layer 32N, and the density of the anode mixture layer 32N are now verified based on comparisons of Examples 1 to 13 and Comparative Examples 1 to 19 shown in FIG. 7.

In Examples 1 to 3, the Li/M ratio was 1.16, and the density of the anode mixture layer 32N was 1.2 g/cc. The amount of lithium contained in the anode mixture layer 32N was 1000 ppm in Example 1, and 1280 ppm in Example 2, and 1500 ppm in Example 3. Therefore, in Examples 1 to 3, the Li/M ratio, the amount of lithium contained in the anode mixture layer 32N, and the density of the anode mixture layer 32N were all within the above-described preferred ranges.

When Examples 1 to 3 are compared to Comparative Example 1 to Comparative Example 5, which had a Li/M ratio of 1.13, Examples 1 to 3 obtained higher battery outputs. The deterioration rate of the battery capacity was substantially the same between Examples 1 to Example 3 and Comparative Examples 1 to 5.

Further, Examples 1 to 3 are compared to Comparative Examples 6 and 7, in which the Li/M ratio and the density of the anode mixture layer 32N were equal to those in Examples 1 to 3, and the amount of lithium contained in the anode mixture layer 32N was set to 0 ppm in Comparative Example 6, and 600 ppm in Comparative Example 7. In this case, Examples 1 to 3 obtained substantially the same battery outputs as Comparative Examples 6 and 7. The deterioration rate of the battery capacity was lower in Examples 1 to 3 than in Comparative Examples 6 and 7.

In Examples 4 to 6, the Li/M ratio was 1.18. The density of the anode mixture layer 32N in Examples 4 to 6 was 1.2 g/cc, which is the same as Examples 1 to 3. The amount of lithium contained in the anode mixture layer 32N was 1000 ppm in Example 4, 1280 ppm in Example 5, and 1500 ppm in Example 6. Therefore, in Examples 4 to 6, the Li/M ratio, the amount of lithium contained in the anode mixture layer 32N, and the density of the anode mixture layer 32N were also all within the above-described preferred ranges.

When Examples 4 to 6 are compared to Examples 1 to 3, which had relatively low Li/M ratios, Examples 4 to 6 obtained higher battery outputs. Further, Examples 4 to 6 are compared to Comparative Examples 8 and 9, in which the Li/M ratio and the density of the anode mixture layer 32N were equal to those in Examples 4 to 6, and the amount of lithium contained in the anode mixture layer 32N was set to 0 ppm in Comparative Example 8, and 600 ppm in Comparative Example 9. In this case, Examples 4 to 6 obtained substantially the same battery outputs as Comparative Examples 8 and 9. The deterioration rate of the battery capacity was lower in Examples 4 to 6 than in Comparative Examples 8 and 9.

In Example 7, the Li/M ratio was 1.20. The density of the anode mixture layer 32N in Example 7 was 1.2 g/cc, which is the same as Examples 1 to 6. The amount of lithium contained in the anode mixture layer 32N was 1000 ppm, which is the same as Examples 1 and 4. Therefore, in Examples 7, the Li/M ratio, the amount of lithium contained in the anode mixture layer 32N, and the density of the anode mixture layer 32N were also all within the above-described preferred ranges.

When Example 7 is compared to Examples 1 to 6, which had relatively low Li/M ratios, Example 7 obtained a higher battery output. Further, Example 7 is compared to Comparative Examples 10 to 15, in which the Li/M ratio was the same as Example 7, and the amount of lithium contained in the anode mixture layer 32N was set to 0 ppm in Comparative Examples 10 to 14, and 600 ppm in Comparative Example 15. In this case, Example 7 obtained substantially the same battery output as Comparative Examples 10 and 15. The deterioration rate of the battery capacity was lower in Example 7 than in Comparative Examples 10 to 15.

In Examples 8 to 10, the Li/M ratio was set to 1.20, which is the same as Example 7. The amount of lithium contained in the anode mixture layer 32N was 1280 ppm in Example 8 to Example 10. The density of the anode mixture layer 32N was 1.1 g/cc in Example 8, 1.2 g/cc in Example 9, and 1.4 g/cc in Example 10. Therefore, in Examples 8 to 10, the Li/M ratio, the amount of lithium contained in the anode mixture layer 32N, and the density of the anode mixture layer 32N were also all within the above-described preferred ranges.

Examples 8 to 10 obtained substantially the same battery outputs as Example 7, which had the same Li/M ratio. The deterioration rate of the battery capacity was lower in Examples 8 to 10 than in Example 7, which had a relatively small amount of lithium in the anode mixture layer 32N.

In Examples 11 to 13, the Li/M ratio was set to 1.20, which is the same as Examples 7 to 10. The amount of lithium contained in the anode mixture layer 32N was 1500 ppm in Examples 11 to 13. The density of the anode mixture layer 32N was 1.1 g/cc in Example 11 in the same manner as Example 8, 1.2 g/cc in Example 12 in the same manner as Example 9, and 1.4 g/cc in Example 13 in the same manner as Example 10. Therefore, in Examples 11 to 13, the Li/M ratio, the amount of lithium contained in the anode mixture layer 32N, and the density of the anode mixture layer 32N were also all within the above-described preferred ranges.

Examples 11 to 13 also obtained substantially the same battery outputs as Examples 7 to 10, which had the same Li/M ratio. The deterioration rate of the battery capacity was lower in Examples 11 to 13 than in Examples 7 to 9, which had relatively small amounts of lithium in the anode mixture layer 32N.

Further, Examples 8 to 10 are compared to Comparative Examples 16 and 17, in which the Li/M ratio and the amount of lithium in the anode mixture layer 32N were all the same as those in Examples 8 to 10. In this case, the deterioration rate was lower in Examples 8 to 10 and Comparative Example 16, in which the density of the anode mixture layers 32N was less than or equal to 1.4 g/cc, than in Comparative Example 17, in which the density of the anode mixture layer 32N was 1.6 g/cc. Further, Examples 11 to 13 are compared to Comparative Examples 18 and 19, in which the Li/M ratio and the amount of lithium in the anode mixture layer 32N were also all the same as those in Examples 11 to 13. In this case, the deterioration rate was also lower in Examples 11 to 13 and Comparative Example 18, in which the density of the anode mixture layers 32N was less than or equal to 1.4 g/cc, than in Comparative Examples 19, in which the density of the anode mixture layer 32N was 1.6 g/cc.

In this manner, the battery output and the battery life were effectively improved in Examples 1 to Example 13, in which the Li/M ratio, the amount of lithium contained in the anode mixture layer 32N, and the density of the anode mixture layer 32N were all within the preferred ranges described above. The verification result also confirms that the preferred ranges obtained by combining the following conditions are appropriate. The conditions include that the anode mixture layer 32N contains greater than or equal to 1000 ppm and less than or equal to 1500 ppm of lithium, the density of the anode mixture layer 32N is greater than or equal to 1.1 g/cc and less than or equal to 1.4 g/cc, and the Li/M ratio of lithium transition metal oxide contained in the cathode mixture layer 32P is greater than or equal to 1.16 and less than or equal to 1.20.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A lithium-ion rechargeable battery, comprising:
an electrode body in which an electrode sheet of a cathode and an electrode sheet of an anode are stacked with a separator arranged in between, each of the electrode sheets being formed by an electrode mixture applied to a substrate serving as a current collector, an opposing surface of an anode mixture layer in the electrode sheet of the anode being greater in size than an opposing surface of a cathode mixture layer in the electrode sheet of the cathode, wherein:
the anode mixture layer contains greater than or equal to 1000 ppm and less than or equal to 1500 ppm of lithium in advance;
the anode mixture layer has a density that is greater than or equal to 1.1 g/cc and less than or equal to 1.4 g/cc; and
the cathode mixture layer contains a lithium transition metal oxide as a cathode active material, and a Li/M ratio of a number (Li) of atoms of lithium to a sum (M) of a number of atoms of a transition metal in the lithium transition metal oxide is greater than or equal to 1.16 and less than or equal to 1.20.

2. The lithium-ion rechargeable battery according to claim 1, wherein the lithium contained in the anode mixture layer in advance derives from carboxymethyl cellulose lithium included in an anode mixture, which forms the anode mixture layer.

3. The lithium-ion rechargeable battery according to claim 2, wherein the anode mixture contains greater than or equal to 0.4 wt % and less than or equal to 0.6 wt % of the carboxymethyl cellulose lithium.

4. The lithium-ion rechargeable battery according to claim 1, wherein the lithium transition metal oxide contained in the cathode mixture layer includes LiNiₓCo_{y}Mn_{z}O₂ (x+y+z=1,0<x<1,0<y<1,0<z<1).

5. The lithium-ion rechargeable battery according to claim 1, wherein an anode capacity/cathode capacity ratio of the electrode sheet of the cathode and the electrode sheet of the anode is greater than or equal to 1.6 and less than or equal to 1.8.

6. The lithium-ion rechargeable battery according to claim 1, wherein an end region of each of the electrode sheets defines an uncoated portion where the electrode mixture is not applied to the substrate, and the electrode sheet of the anode includes the end region in which the uncoated has a width of 300 μm or less.

7. The lithium-ion rechargeable battery according to claim 1, wherein the separator has a porosity that is greater than or equal to 50% and less than or equal to 60%.
